(19) United States
(12) Patent Application Publication
(10) Pub. No.: US 2015/0047628 A1
(43) Pub. Date: Feb. 19, 2015

(54) Heat directing device for a gas fireplace

(71) Applicant: James Edward Beasley, Angier, NC (US)

(72) Inventor: James Edward Beasley, Angier, NC (US)

(21) Appl. No.: 14/459,534

(22) Filed: Aug. 14, 2014

Related U.S. Application Data
(60) Provisional application No. 61/865,643, filed on Aug. 14, 2013.

(51) Int. Cl. F24B 1/189; B23P 19/04

(52) U.S. Cl. CPC F24B 1/1895; B23P 19/04
USPC 126/509; 29/428; 126/536

(57) ABSTRACT

A heat directing device for a gas fireplace, which directs warm air into another room or rooms by joining to the home's central heating floor or wall registers. The heat directing device features an electronic damper and a single speed fan, wired in series and controlled by a wall mounted switch located near the gas fireplace. The device is constructed using an 18-gauge single wall pipe, preferably eight inches in diameter. The electronic damper is mounted internally within the wall pipe, and the single speed fan is mounted internally in line with the damper, nearer to the gas fireplace. An extension pipe links the wall pipe output to a Y-shaped member, which is installed within the floor or wall register of a room to be heated.

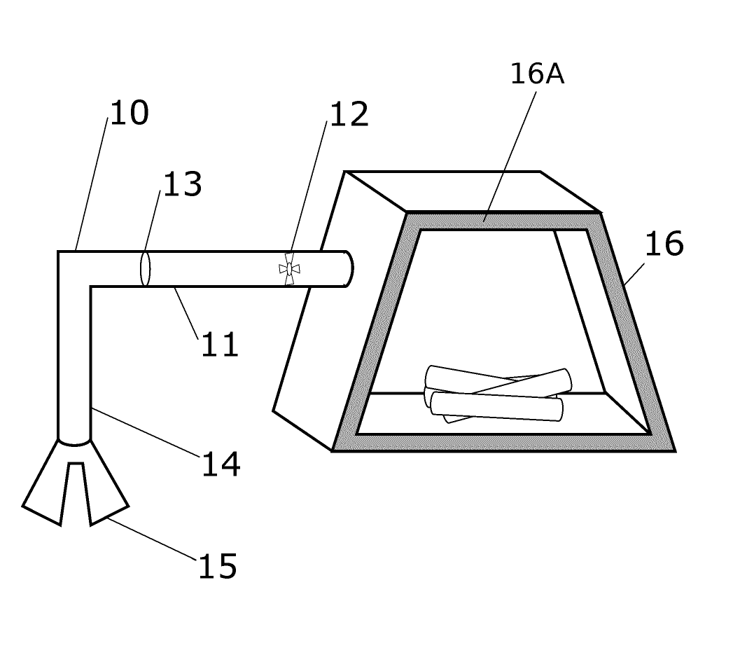

### CROSS-REFERENCE TO RELATED APPLICATIONS

This application claims the benefit of U.S. Provisional Application No. 61/865643, filed Aug. 14, 2013, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to heating accessories and in particular to heat directing device for a gas fireplace. The owners of homes with gas fireplaces can confirm that a gas fireplace is an economical and effective way to heat portions of a home. Unfortunately, any portion of a home that is not heated by a gas fireplace is often too cold, and the rooms that have gas fireplaces may become too warm due to efforts to warm the colder rooms. A heat directing device for a gas fireplace, which directs warm air into another room by joining to the home's floor or wall registers, would resolve this problem. The heat directing device features an electronic damper and a single speed fan, controlled by a wall mounted switch located near the gas fireplace.

### SUMMARY OF THE INVENTION

Accordingly, the invention is directed to a heat directing device for a gas fireplace, which directs warm air into another room or rooms by joining to the home's central heating floor or wall registers. The heat directing device features an electronic damper and a single speed fan, wired in series and controlled by a wall mounted switch located near the gas fireplace. The device is constructed using an 18-gauge single wall pipe, preferably eight inches in diameter. The electronic damper is mounted internally within the wall pipe, and the single speed fan is mounted internally in line with the damper, nearer to the gas fireplace. An extension pipe links the wall pipe output to a Y-shaped member, which is installed within the floor or wall register of a room to be heated.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and is incorporated into and constitute a part of the specification. It illustrates one embodiment of the invention and, together with the description, serves to explain the principles of the invention.

The FIGURE shows a front perspective view of the first exemplary embodiment mounted on a gas fireplace, displaying the heat directing device 10, the wall pipe 11, the single speed fan 12, the electronic damper 13, the extension pipe 14, the Y-shaped member 15, the gas fireplace 16, and the gap 16A.

### DETAILED DESCRIPTION OF THE INVENTION

Referring now to the invention in more detail, the invention is directed to a heat directing device 10 for a gas fireplace 16, which directs warm air from the gas fireplace 16 into the home's central heating floor or wall registers of another room (the invention may similarly be practiced in a building or structure other than a home, generically a “structure”). Access to the floor or wall vents is preferable to directly accessing the heating system ducts because modifications to the ductwork may impact furnace warranty terms, local building restrictions, and other applicable rules. The heat directing device 10 features an electronic damper 13 and a single speed fan 12, wired in series and controlled by a wall mounted switch located near the gas fireplace 16. The device is preferably constructed using an 18-gauge single wall pipe 11, eight inches in diameter and in fluid communication with the gap 16A. The electronic damper 13 is preferably mounted internally, and the single speed fan 12 is preferably mounted internally in line with the electronic damper 13 and nearer to the gas fireplace 16.

The device operates by transferring heated air from the gas fireplace 16, from the gap 16A between the firebox and the sheet metal around the firebox (in general, the radiant heat of the fireplace 16 or other heat source warms an isolated quantity of air in the gap 16A), into the additional room. The wall pipe 11 is preferably joined to the heating vents 15 with an extension pipe 14. The extension pipe 14 is preferably a long flexible pipe run from the room having the fireplace 16 to the room desired to be heated, for example a master bedroom. The extension pipe 14 is preferably run below or above the house through an access area or crawl space, as permitted by the layout of the particular home and the locations of the heat-receiving room and the fireplace 16. The extension pipe 14 is in fluid communication with the wall pipe 11 and the Y-shaped member 15. The Y-shaped member 15 is installed within the floor or wall registers or vents of the room to be heated such that warm air moving through the extension pipe 14 will be forced out of the floor or wall register and will tend not to enter the central heating ducts. This is achieved by cutting an access hole into the boot portion of the floor or wall register or vent and inserting the Y-shaped member such that the Y-shaped member will be retained therein by friction without obstructing the existing duct access to the same floor or wall register or vent. The extension pipe 14 is preferably constructed using a flexible, heat resistant piping material. Electronic components of the device include an electronic damper 13, a single speed fan 12, an on/off switch, and a power cord that is preferably permanently connected to the house's electrical system. The device is designed for use with most gas fireplaces. Air flow from the gas fireplace 16 is controlled by the electronic damper 13.

To use the first exemplary embodiment, the user starts the gas fireplace 16 and activates the wall mounted on/off switch. The user preferably turns off the home's central heating system, allowing the invention to access the central heating system without interfering with normal operation and airflow. The single speed fan 12 drives heated air from the gap 16A into the Y-shaped member 15 and out of the floor or wall registers or vents via the wall pipe 11 and extension pipe 14. The electronic damper 13 controls air flow.

The wall pipe 11 and the extension pipe 14 are preferably manufactured from rigid, durable metal components such as 18-gauge wall pipe, eight inches in diameter, manufactured from galvanized steel or aluminum. The single speed fan 12 and the electronic damper 13 are preferably manufactured from rigid, durable materials such as steel, aluminum, copper alloys, and high-impact plastic. The gas fireplace 16 may be replaced by an alternative heat source, for example a wood burning fireplace or stove, electric or radiant heating device, etc.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A heat directing system for a fireplace comprising a fireplace; said fireplace being surrounded by a gap; a wall pipe; an extension pipe; said wall pipe being in fluid communication with said gap; said wall pipe being in fluid communication with said extension pipe; a Y-shaped member; and said extension pipe being in fluid communication with said Y-shaped member; whereby heated air from said gap may be communicated into said Y-shaped member.

2. The heat directing system for a fireplace of claim 1 further comprising an electronic damper; a single-speed fan; said electronic damper and said single speed fan being wired in series and under common electrical control; said electronic damper and single speed fan being disposed within said wall pipe such that activation of said electronic damper and single speed fan will allow and direct airflow from said gap to said Y-shaped member, and such that deactivation of said electronic damper and said single speed fan will retard and not direct airflow through said wall pipe.

3. A method of installing the heat directing system of claim 1 comprising affixing said extension pipe to said gap; affixing said extension pipe to said wall pipe, running said extension pipe through an access area to any of the group of a floor register, a floor vent, a wall register, or a wall vent, such that said Y-shaped member is in fluid communication therewith.

4. A method of installing the heat directing system of claim 2 comprising affixing said extension pipe to said gap; affixing said extension pipe to said wall pipe, running said extension pipe through an access area to any of the group of a floor register, a floor vent, a wall register, or a wall vent, such that said Y-shaped member is in fluid communication therewith.

5. A method of use of the heat directing system of claim 1 comprising activating said fireplace and deactivating the heating system associated with the structure in which said fireplace is installed.

6. A method of use of the heat directing system of claim 2 comprising activating said fireplace and deactivating the heating system associated with the structure in which said fireplace is installed.

7. The method of claim 6 further comprising activating said electronic damper and said single speed fan, whereby heated air is directed from said gap into said heating vents.

8. A method of use of the heat directing system installed according to the method of claim 3 comprising activating said fireplace and deactivating the heating system associated with the structure in which said fireplace is installed.

9. A method of use of the heat directing system installed according to the method of claim 4 comprising activating said fireplace and deactivating the heating system associated with the structure in which said fireplace is installed.

10. The method of claim 9 further comprising activating said electronic damper and said single speed fan, whereby heated air is directed from said gap into said heating vents.
